(19) United States
(12) Patent Application Publication
(10) Pub. No.: US 2025/0349232 A1
(43) Pub. Date: Nov. 13, 2025

(54) SYSTEMS AND METHODS FOR ASSISSTING A WORKER FOR MANAGING GOODS WITHIN A WAREHOUSE

(71) Applicant: Honeywell International Inc., Charlotte, NC (US)

(72) Inventor: Rohit Rushil Alluri, Hyderabad (IN)

(21) Appl. No.: 19/045,589

(22) Filed: Feb. 5, 2025

(30) Foreign Application Priority Data
May 7, 2024 (IN) 202411036021

(51) Int. Cl. G09G 3/00; G06Q 10/087

(52) U.S. Cl. CPC G09G 3/001; G06Q 10/087

(57) ABSTRACT

A system and method for assisting a worker for managing goods within a warehouse are disclosed. The method comprises receiving, via at least one processor, at least one input request from a user; comparing, via the at least one processor, the at least one input request having an identification (ID) code with a corresponding ID code of an at least one object; determining, via the at least one processor, location information of the at least one object to be picked or placed over the at least one rack, based on the comparison; and directing, via the at least one processor, a plurality of sensors placed at one or more positions of the at least one rack, to rotate and project a light beam at the shelf of the at least one rack from where the at least one object to be picked or placed, based on the determined location information.

### TECHNOLOGICAL FIELD

The present invention relates to warehouse management system (WMS), and more particularly relates to systems and methods for assisting a worker for managing goods within a warehouse.

### BACKGROUND

A warehouse is a large building or facility where goods, materials, or products are stored, organized, and managed before they are distributed, sold, or used in manufacturing or other processes. The warehouse plays a crucial role in supply chains, logistics, and distribution networks, serving as hubs for inventory management and distribution. In these inventories, the warehouse is equipped with racks and shelves. The racks and shelves inside the warehouse plays a crucial role in optimizing storage space, facilitating efficient inventory management, and improving the overall workflow of warehouse operations. The warehouse can be equipped with hundreds and thousands of such racks and shelves stored with the inventories. To manage such inventories within the hundreds and thousands of such racks and shelves is a cumbersome and time consuming task. Therefore, managers are appointed for conducting warehouse management operations.

Warehouse management encompasses the principles and processes involved in running day-to-day operations of the warehouse. The management in the warehouse manages inventory in the warehouse, including tracking quantities, monitoring expiration dates, picking products, placing products and organizing products based on customer demand. The traditional process of warehouse picking often involves workers spending considerable time in determining location metrics to locate items within the shelves or the racks of the warehouse. Such process of picking or placing the items is not only time-consuming but also prone to errors, leading to inefficiencies in the overall operation. Workers may struggle to accurately determine location systems, resulting in delays and increased labor costs. Additionally, the need for extensive training to familiarize workers with these location metrics further adds to the time and cost burden.

The inventors have identified numerous areas of improvement in the existing technologies and processes, which are the subjects of embodiments described herein. Through applied effort, ingenuity, and innovation, many of these deficiencies, challenges, and problems have been solved by developing solutions that are included in embodiments of the present disclosure, some examples of which are described in detail herein.

### BRIEF SUMMARY

The following presents a simplified summary in order to provide a basic understanding of some aspects of the present disclosure. This summary is not an extensive overview and is intended to neither identify key or critical elements nor delineate the scope of such elements. Its purpose is to present some concepts of the described features in a simplified form as a prelude to the more detailed description that is presented later.

In an example embodiment, a method is disclosed. The method comprises receiving, via at least one processor, at least one input request from a user. The at least one input request comprises an identification (ID) code corresponding to at least one object to be picked from at least one rack or placed over at least one rack. Further, the method comprises comparing, via the at least one processor, the received at least one input request having the ID code with a corresponding ID code of the at least one object saved within a memory communicatively coupled to the at least one processor. Further, the method comprises determining, via the at least one processor, location information of the at least one object to be picked from the at least one rack or placed over the at least one rack, based at least on the comparison. The location information comprises location coordinates and a shelf number related to a shelf from a plurality of shelves of the at least one rack where the at least one object to be picked or placed. Thereafter, the method comprises directing, via the at least one processor, a plurality of sensors placed at one or more positions of the at least one rack, to rotate and project a light beam at the shelf of the at least one rack from where the at least one object to be picked or placed, based at least on the determined location information. The light beam from the plurality of sensors forms an intersection point over the shelf of the at least one rack to indicate the user from where the at least one object to be picked or placed.

In some embodiments, the one or more positions of the at least one rack comprises at least one of a placement of each of the plurality of sensors in at least top corners of the at least one rack, in at least top and bottom sides of the at least one rack, or in at least diagonal corners of the at least one rack.

In some embodiments, the one or more sensors comprises at least one of a laser sensor, light emitting diode (LED) sensor, or a projector sensor.

In some embodiments, the at least one processor is configured to rotate the plurality of sensors using at least one actuator. The at least one actuator is mechanically or electrically coupled to the plurality of sensors.

In some embodiments, the method further comprises determining, via the at least one processor, one or more angle values corresponding to the determined location coordinates of the shelf of the at least one rack from where the at least one object to be picked or placed, using the plurality of sensors. In some embodiments, the at least one processor is configured to actuate the at least one actuator based at least on the determined one or more angle values, to rotate and project the light beam over the shelf of the at least one rack from where the at least one object to be picked or placed. In some embodiments, the at least one processor is configured to direct the plurality of sensors placed at the one or more positions of the at least one rack, to rotate in anticlockwise direction and in clockwise direction using the at least one actuator, to form the intersection point over the shelf of the at least one rack.

In some embodiments, the at least one processor is communicatively coupled to a user device having an application. The user device is configured to receive the at least one input request from the user using the application.

In another example embodiment, a system is disclosed. The system comprises a memory and at least one processor communicatively coupled to the memory. The at least one processor is configured to receive at least one input request from a user. The at least one input request comprises an identification (ID) code corresponding to at least one object to be picked from at least one rack or placed over the at least one rack. Further, the at least one processor is configured to compare the received at least one input request having the ID code with a corresponding ID code of the at least one object saved within a memory communicatively coupled to the at least one processor. Further, the at least one processor is configured to determine location information of the at least one object to be picked from the at least one rack or placed over the at least one rack, based at least on the comparison. The location information comprises location coordinates and a shelf number related to a shelf from a plurality of shelves of the at least one rack where the at least one object to be picked or placed. Thereafter, the at least one processor is configured to direct a plurality of sensors placed at one or more positions of the at least one rack, to rotate and project a light beam at the shelf of the at least one rack from where the at least one object to be picked or placed, based at least on the determined location information. The light beam from the plurality of sensors forms an intersection point over the shelf of the at least one rack to indicate the user from where the at least one object to be picked or placed.

In some embodiments, the one or more positions of the at least one rack comprises at least one of a placement of each of the plurality of sensors in at least top corners of the at least one rack, in at least top and bottom sides of the at least one rack, or in at least diagonal corners of the at least one rack.

In some embodiments, the one or more sensors comprises at least one of a laser sensor, light emitting diode (LED) sensor, or a projector sensor.

In some embodiments, the at least one processor is configured to rotate the plurality of sensors using at least one actuator. The at least one actuator is mechanically or electrically coupled to the plurality of sensors. In some embodiments, the at least one processor is configured to determine one or more angle values corresponding to the determined location coordinates of the shelf of the at least one rack from where the at least one object to be picked or placed, using the plurality of sensors. In some embodiments, the at least one processor is configured to actuate the at least one actuator based at least on the determined one or more angle values, to rotate and project the light beam at the shelf of the at least one rack from where the at least one object to be picked or placed.

In some embodiments, the at least one processor is configured to direct the plurality of sensors placed at the one or more positions of the at least one rack, to rotate in anticlockwise direction and in clockwise direction using the at least one actuator, to form the intersection point over the shelf of the at least one rack.

In some embodiments, the at least one processor is communicatively coupled to a user device having an application. The user device is configured to receive the at least one input request from the user using the application.

In another example embodiment, a non-transitory machine-readable information storage medium is disclosed. The non-transitory machine-readable information storage medium comprising one or more instructions which when executed by at least one processor to perform operations comprising receiving at least one input request from a user, wherein the at least one input request comprises an identification (ID) code corresponding to at least one object to be picked from at least one rack or placed over the at least one rack; comparing the received at least one input request having the ID code with a corresponding ID code of the at least one object saved within a memory communicatively coupled to the at least one processor; determining location information of the at least one object to be picked from the at least one rack or placed over the at least one rack, based at least on the comparison, wherein the location information comprises location coordinates and a shelf number related to a shelf from a plurality of shelves of the at least one rack where the at least one object to be picked or placed; and directing a plurality of sensors placed at one or more positions of the at least one rack, to rotate and project a light beam at the shelf of the at least one rack from where the at least one object to be picked or placed, based at least on the determined location information, wherein the light beam from the plurality of sensors forms an intersection point over the shelf of the at least one rack to indicate the user from where the at least one object to be picked or placed.

The above summary is provided merely for purposes of summarizing some example embodiments to provide a basic understanding of some aspects of the invention. Accordingly, it will be appreciated that the above-described embodiments are merely examples and should not be construed to narrow the scope or spirit of the invention in any way. It will be appreciated that the scope of the invention encompasses many potential embodiments in addition to those here summarized, some of which will be further described below.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 illustrates a network diagram of a system for assisting a user for managing goods within a warehouse in accordance with an example embodiment of the present disclosure;

FIG. 2 illustrates a block diagram of a server in accordance with an example embodiment of the present disclosure;

FIG. 3 illustrates a block diagram showing an operation of the system for assisting the user for managing goods within the warehouse in accordance with an example embodiment of the present disclosure;

FIG. 4 illustrates a working scenario of the user interacting with the system via a user device in accordance with an example embodiment of the present disclosure;

FIGS. 5A-5C illustrate a front view of the user device installed with an application in accordance with an example embodiment of the present disclosure;

FIG. 6 illustrates a table showing a database stored within a memory in accordance with an example embodiment of the present disclosure;

FIG. 7 illustrates another table showing one or more angle values of corresponding location coordinates in accordance with an example embodiment of the present disclosure;

FIG. 8 illustrates an exemplary scenario showing an intersection point of a light beam projected by a plurality of sensors over at least one object in accordance with an example embodiment of the present disclosure;

FIG. 9 illustrates a perspective view of at least one sensor from a plurality of sensors in accordance with an example embodiment of the present disclosure;

FIG. 10A illustrates a front view of the at least one rack installed with the plurality of sensors in at least top corners of the at least one rack in accordance with an example embodiment of the present disclosure;

FIG. 10B illustrates another front view of the at least one rack installed with the plurality of sensors in at least top and bottom sides of the at least one rack in accordance with an example embodiment of the present disclosure;

FIG. 10C illustrates another front view of the at least one rack installed with the plurality of sensors in at least diagonal corners of the at least one rack in accordance with an example embodiment of the present disclosure;

FIG. 11 illustrates a flowchart showing a method for assisting the user for managing goods within the warehouse in accordance with an example embodiment of the present disclosure;

FIG. 12A illustrates a schematic view of at least one sensor installed at a roof of a warehouse in accordance with an alternate embodiment of the present disclosure; and

FIG. 12B illustrates another schematic view of the at least one sensor installed at a floor of the warehouse in accordance with another alternate embodiment of the present disclosure.

### DETAILED DESCRIPTION

Some embodiments will now be described more fully hereinafter with reference to the accompanying drawings, in which some, but not all, embodiments are shown. Indeed, various embodiments may be embodied in many different forms and should not be construed as limited to the embodiments set forth herein; rather, these embodiments are provided so that this disclosure will satisfy applicable legal requirements. As discussed herein, the protection devices may be referred to use by humans, but may also be used to raise and lower objects unless otherwise noted.

The components illustrated in the figures represent components that may or may not be present in various embodiments of the invention described herein such that embodiments may include fewer or more components than those shown in the figures while not departing from the scope of the invention. Some components may be omitted from one or more figures or shown in dashed line for visibility of the underlying components.

The present disclosure provides various embodiments of methods and systems for assisting a worker for managing goods within a warehouse. Embodiments may be configured to receive at least one input request from the user. Embodiments may be configured to compare the received at least one input request having the ID code with a corresponding ID code of the at least one object saved within a memory communicatively coupled to at least one processor. Embodiments may be further configured to determine location information of the at least one object to be picked from the at least one rack or placed over the at least one rack, based at least on the comparison. Thereafter, embodiments may be configured to direct a plurality of sensors placed at one or more positions of the at least one rack, to rotate and project a light beam at the shelf of the at least one rack from where the at least one object to be picked or placed, based at least on the determined location information.

Embodiments may be configured to rotate the plurality of sensors using at least one actuator. The actuator is mechanically or electrically coupled to the plurality of sensors. Embodiments may be configured to determine one or more angle values corresponding to the determined location coordinates of the shelf of the at least one rack from where the at least one object to be picked or placed, using the plurality of sensors. Embodiments may be configured to actuate the at least one actuator based at least on the determined one or more angle values, to rotate and project the light beam over the shelf of the at least one rack from where the at least one object to be picked or placed. Embodiments may be configured to direct the plurality of sensors placed at the one or more positions of the at least one rack, to rotate in anticlockwise direction and in clockwise direction using the at least one actuator, to form the intersection point over the shelf of the at least one rack. Embodiments may be configured to receive the at least one input request from the user using the application.

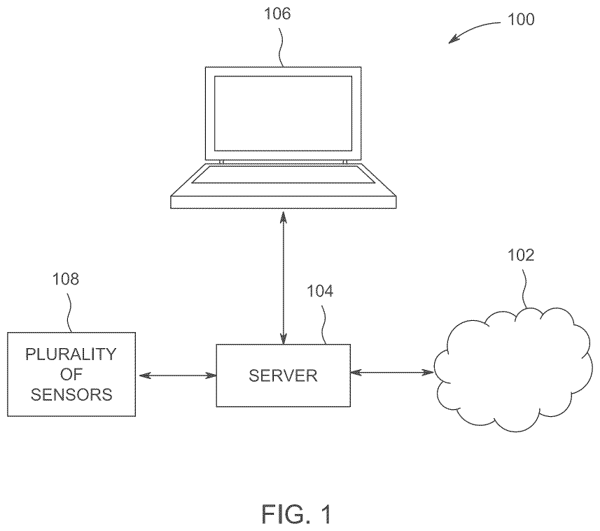

FIG. 1 illustrates a network diagram of a system 100 for assisting a user for managing goods within a warehouse, in accordance with an example embodiment of the present disclosure. The system 100 may comprise a network 102 and a server 104. The system 100 may further comprise a user device 106 and a plurality of sensors 108.

In some embodiments, the network 102 may be a communication network such as Internet or a cloud network, that may be configured to allow computing devices and processing systems to communicate with each other through wired network, wireless network, or a combination of both. In some embodiments, the network 102 may refer to as a distributed infrastructure that is configured to exchange of data, information, and resources among interconnected computing devices and systems. The network 102 may be designed to facilitate communication and collaboration across various locations, devices, and platforms. Those skilled in the art will recognize that wired devices may include, but are not limited to, wired networks such as wide area networks (WANs) or local area networks (LANs), while wireless devices may include wireless communications established via radio frequency (RF) signals or infrared signals. Further, various devices in the system 100 may connect to the network 102 in accordance with various wired and wireless communication protocols such as transmission control protocol and internet protocol (TCP/IP), user datagram protocol (UDP), and 2G, 3G, or 4G communication protocols.

Further, the system 100 may be associated with a warehouse (not shown). Further, the warehouse may be a commercial building designed for the storage and handling of a plurality of objects. In some embodiments, warehouse may serve as a location for storing the plurality of objects in manufacturing operations. In some embodiments, the system 100 facilitate efficient management of one or more warehouse operations related to the warehouse. The one or more warehouse operations may comprise tracking of each of the plurality of objects, picking of at least one object from the plurality of objects, and placing of the at least one object from the plurality of objects. In some embodiments, the warehouse may further comprise at least one rack (not shown). In some embodiments, the at least one rack may be configured to store the plurality of objects. Further, the at least one rack may comprise a plurality of shelves (not shown). Further, each shelf from the plurality of shelves may be configured to contain the at least one object from the plurality of objects. In some embodiments, the at least one object may comprise at least one of at least one parcel, household cartons, and a plurality of industrial machineries.

In some embodiments, the system 100 may comprise the user device 106. Further, the user device 106 may be accessed by a user to provide at least one input request. In some embodiments, the user may be referred to as a worker. In some embodiments, the at least one input request may comprise at least an identification (ID) code corresponding to the at least one object to be picked from the at least one rack or placed over the at least one rack. In at least one example, the at least one input request may be provided by the user through the user device 106. Further, the user device 106 may comprise at least one of a mobile phone, tablet, laptop, etc. Further, the user device 106 may be communicatively coupled with the server 104 through the network 102. Further, the user device 106 may be installed with an application that may provide a software platform to the user to provide the at least one input request. In at least one example, the at least one input request may comprise the ID code corresponding to the at least one object, while picking the at least one object from the at least one rack. In another example, the at least one input request may comprise a shelf ID code or a rack ID code, while placing the at least object into the at least one rack. In another example, the at least one input request may correspond to a unique ID code having one or more unique characters.

In some embodiments, the server 104 may be a computer or software module that is configured to provide centralized resources, data, or services to the user device 106 operated by a user. The server 104 may be configured to handle and manage one or more computational tasks and data processing within the system 100. In some embodiments, the server 104 may include storage systems, such as hard drives or storage arrays, to store and manage large volumes of data and information accessible to network users. In some embodiments, the server 104 may further provide centralized control and management capabilities, allowing network administrators to configure, monitor, and maintain network resources, security settings, and user access permissions from a single location.

In some embodiments, the server 104 may be configured to receive the at least one input request from the user device 106. In at least one example, the at least one input request may comprise the ID code corresponding to the at least one object to be picked from the at least one rack. In another example, the at least one input request may comprise the ID code corresponding to the at least one object to be placed over the at least one rack. In various other examples, the at least one input request may comprise the ID code corresponding to the shelf ID code or the rack ID code.

Further, the server 104 may comprise a memory (not shown). Further, the memory may be configured to store a database associated with an inventory record of the warehouse. Further, the database may comprise a plurality of ID code(s) corresponding to at least one object to be picked from at least one rack or placed over the at least one rack. Further, the database may comprise rack no., shelf no., ID code, corresponding ID code, and location coordinates. Further, the server 104 may be configured to compare the received at least one input request by the user having the ID code with a corresponding ID code of the at least one object. In some embodiments, the corresponding ID code of the at least one object may be pre-saved within the memory. In some embodiments, the server 104 may examine each of the at least one input request to identify matching ID codes among the stored data. Further, the server 104 may be configured to compare the received ID code with the corresponding ID code by at least one synchronous approach.

In some embodiments, the server 104 may be configured to determine location information of the at least one object to be picked from the at least one rack or placed over the at least one rack, based at least on the comparison. In some embodiments, the location information comprises location coordinates and a shelf number related to at least one shelf from the plurality of shelves of the at least one rack where the at least one object to be picked or placed. Further, the location information may be saved within the memory or the database. In some embodiments, the server 104 may be configured to determine one or more angle values of the shelf from the plurality of shelves of the rack from where the at least one object to be picked or when the at least one object to be placed.

In some embodiments, the system 100 may further comprise the plurality of sensors 108. In some embodiments, each sensor from the plurality of sensors 108 may be configured to project a light beam in one or more directions. Further, the server 104 may be configured to direct the plurality of sensors 108 placed at one or more positions of the at least one rack. In at least one example, the one or more positions may correspond to at least top corners of the at least one rack. In another example, the one or more positions may correspond to at least top sides of the at least one rack. In another examples, the one or more positions may correspond to at least bottom sides of the at least one rack. In various other examples, the one or more positions may correspond to at least diagonal corners of the at least one rack. Further, the plurality of sensors 108 may comprise at least one of a laser sensor, light emitting diode (LED) sensor, or a projector sensor. Further, the plurality of sensors 108 may be configured to rotate and project the light beam at the shelf of the at least one rack from where the at least one object to be picked or placed, based at least on the determined location information. The light beam from the plurality of sensors 108 forms an intersection point over the shelf of the at least one rack to indicate the user from where the at least one object to be picked or placed. In some embodiments, the one or more positions of the at least one rack may comprise at least one of a placement of each of the plurality of sensors 108 on the at least one rack.

In some embodiments, the server 104 may be configured to indicate the determined location coordinates of the shelf of the at least one rack from where the at least one object to be picked or placed, using the plurality of sensors 108. Further, each of the plurality of sensors 108 may be installed on at the one or more positions through at least one actuator. Further, the at least one actuator may be configured to provide rotation to each of the plurality of sensors 108 in one or more directions. In some embodiments, the server 104 may be configured to direct the at least one actuator to rotate the plurality of sensors 108. In at least one example, the at least one actuator may be mechanically coupled to the plurality of sensors 108. In another example, the at least one actuator may be electrically coupled to the plurality of sensors 108.

In some embodiments, the server 104 may actuate the at least one actuator based at least on the determined one or more angle values, to rotate each of the plurality of sensors 108. Further, the plurality of sensors 108 may be configured to project the light beam over the shelf of the at least one rack from where the at least one object to be picked or placed. In at least one example, the server 104 may be configured to direct the at least one actuator, to rotate each of the plurality of sensors 108 in an anticlockwise direction to form the intersection point over the shelf of the at least one rack. In another example, the server 104 may be configured to direct the at least one actuator, to rotate each of the plurality of sensors 108 in a clockwise direction using, to form the intersection point over the shelf of the at least one rack.

In some embodiments, the user may follow the intersection point over the shelf of the at least one rack to pick or place the at least one object. In at least one example, the server 104 may be configured to provide the location coordinates over the user device 106. Further, the application may be configured to provide a graphical application showing directions to the user to reach the determined location information associated with the at least one object. In some embodiments, the application may be configured to navigate the user to reach to the shelf from the plurality of shelves where the at least one object to be placed or picked.

It will be apparent to one skilled in the art that above-mentioned components of the system 100 have been provided only for illustration purposes, without departing from the scope of the disclosure.

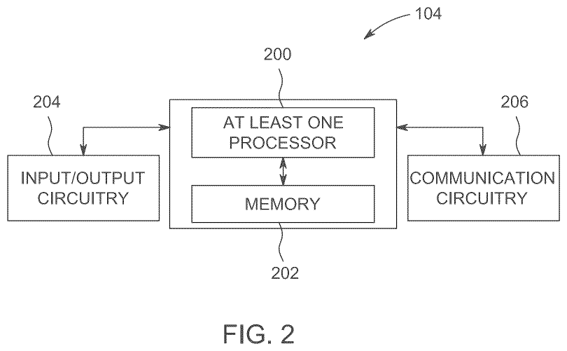

FIG. 2 illustrates a block diagram of the server 104 for assisting the user for managing goods within the warehouse, in accordance with an example embodiment of the present disclosure. FIG. 2 is described in conjunction with FIG. 1. The server 104 may comprise at least one processor 200, a memory 202, an input/output circuitry 204, and a communication circuitry 206.

In some embodiments, the at least one processor 200 may include suitable logic, circuitry, and/or interfaces that are operable to execute one or more instructions stored in the memory 202 to perform predetermined operations. In some embodiments, the at least one processor 200 may be configured to store the one or more fields of the database, the location information, and the determined one or more location coordinates in the memory 202 communicatively coupled to the at least one processor 200. In one embodiment, the at least one processor 200 may be configured to decode and execute any instructions received from one or more other electronic devices or server(s). The at least one processor 200 may be configured to execute one or more computer-readable program instructions, such as program instructions to carry out any of the functions described in this description. Further, the processor may be implemented using one or more processor technologies known in the art. Examples of the at least one processor 200 includes, but are not limited to, one or more general purpose processors and/or one or more special purpose processors.

In some embodiments, the at least one processor 200 of the server 104 may be configured to receive the at least one input request from the user. In some embodiments, the at least one processor 200 may receive the at least one input request through the user device 106. In some embodiments, the user device 106 may comprise keypads or touchscreen interfaces. In some embodiments, the at least one input request may comprise the identification (ID) code corresponding to the at least one object to be picked from or placed onto the at least one rack within the warehouse.

The at least one input request may be provided by the user through the user device 106. Further, the user device 106 may comprise at least one of a mobile phone, tablet, laptop, etc. Further, the user device 106 may be communicatively coupled with the at least one processor 200 of the server 104 through the network 102. Further, the user device 106 may be installed with the application that may provide a software platform to the user to provide the at least one input request. In at least one example, the at least one input request may comprise the ID code corresponding to the at least one object. In another example, the at least one input request may correspond to a unique ID code of the at least one rack. In various other examples, the at least one input request may correspond to a unique ID code of at least one shelf from a plurality of shelves of the at least one rack.

In some embodiments, the at least one processor 200 after receiving the at least one input request from the user device 106, may be configured to compare the ID code with the corresponding ID code of the at least one object saved within the memory 202. The memory 202 may be configured to store the database that may comprise information related to the corresponding ID code of the at least one object. The information may further correspond to a precise location of the at least one object on the shelf from the plurality of shelves of the at least one rack. In some embodiments, the at least one processor 200 may further determine the location information of the at least one object to be picked from the at least one rack or placed over the at least one rack, based at least on the comparison. In some embodiments, the location information may comprise the location coordinates of the at least one object and the shelf number related to the shelf from the plurality of shelves of the at least one rack where the at least one object to be picked or placed. In some embodiments, the at least one processor 200 may be configured to determine the one or more angle values corresponding to the determined location coordinates of the shelf of the at least one rack from where the at least one object to be picked or placed. Further, the at least one processor 200 may be configured to determine the one or more angle values using the plurality of sensors 108.

In some embodiments, the at least one processor 200 may be configured to direct the plurality of sensors 108 to project the light beam at the shelf of the at least one rack from where the at least one object is to be picked or placed. Further, the plurality of sensors 108 may be installed at the one or more positions of the at least one rack. In at least one example, the one or more positions may correspond to at least top corners of the at least one rack. In another example, the one or more positions may correspond to at least top sides of the at least one rack. In another examples, the one or more positions may correspond to at least bottom sides of the at least one rack. In various other examples, the one or more positions may correspond to at least diagonal corners of the at least one rack. Further, the plurality of sensors 108 may comprise at least one of the laser sensor, light emitting diode (LED) sensor, or the projector sensor. Further, each of the plurality of sensors 108 may be configured to rotate in the one or more direction to project the light beam over the shelf from the plurality of shelves when the at least one object to be placed or picked. In some embodiments, the light beam from the plurality of sensors 108 forms the intersection point over the shelf of the at least one rack to indicate the user from where the at least one object to be picked or placed. In some embodiments, the at least one processor 200 may navigate the user in locating the at least one object within the at least one rack through the intersection point.

In some embodiments, each of the plurality of sensors 108 may be placed over the one or more positions of the at least one rack through the at least one actuator. In some embodiments, the at least one processor 200 may be configured to actuate the at least one actuator based at least on the determined one or more angle values, to rotate each of the plurality of sensors 108. Further, the plurality of sensors 108 may be configured to project the light beam over the shelf of the at least one rack. In at least one example, the server 104 may be configured to direct the at least one actuator, to rotate each of the plurality of sensors 108 in the anticlockwise direction to form the intersection point over the shelf of the at least one rack. In another example, the server 104 may be configured to direct the at least one actuator, to rotate each of the plurality of sensors 108 in the clockwise direction using, to form the intersection point over the shelf of the at least one rack.

In some embodiments, the at least one actuator may correspond to a mechanical or an electro-mechanical joint attached to each of the plurality of sensors 108. In some embodiments, the at least one actuator may be configured to rotate one of the plurality of sensors 108 in multiple directions, to direct the light beam towards the shelf of the at least one rack from where the at least one object to be picked or placed. The at least one actuator may be configured to rotate based on the one or more angle values determined by the at least one processor 200. In some embodiments, the at least one actuator may be installed at the one or more positions corresponding to the at least one rack.

In some embodiments, the memory 202 may be configured to store a set of instructions and data executed by the at least one processor 200. Further, the memory 202 may include the one or more instructions that are executable by the at least one processor 200 to perform specific operations. The memory 202 may be configured to include the instructions to receive the at least one input request. Further, the at least one input request may comprise the ID code. The memory 202 may be configured to include the instructions to compare the received at least one input request having the ID code with the corresponding ID code of the at least one object. Further, the memory 202 may be configured to include the instructions to determine location information of the at least one object to be picked from the at least one rack or placed over the at least one rack, based at least on the comparison. Thereafter, the memory 202 may be configured to include the instructions to direct the plurality of sensors 108 placed at the one or more positions of the at least one rack, to rotate and project the light beam at the shelf of the at least one rack from where the at least one object to be picked or placed, based at least on the determined location information,

The memory 202 may be configured to include the at least one input request, the corresponding ID code of the at least one object, and the location information of the at least one object. It is apparent to a person with ordinary skill in the art that the one or more instructions stored in the memory 202 enable the hardware of the system 100 to perform the predetermined operations. Some of the commonly known memory implementations include, but are not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium suitable for storing electronic instructions.

In some embodiments, the server 104 may further comprise the input/output circuity. The input/output circuitry 204 may enable the user to communicate or interface with the system 100, via the user device 106. The user device 106 may include N number of user devices. In some embodiments, the input/output circuitry 204 may act as a medium to transmit input from the interface to and from the system 100. In some embodiments, the input/output circuitry 204 may refer to the hardware and software components that facilitate the exchange of information between the user device 106 and the system 100. In one example, the server 104 may include the application as input circuitry to allow the one or more users to provide the at least one input request. The input/output circuitry 204 may include various input devices such as keyboards, barcode scanners, GUI for the one or more users to provide data and various output devices such as displays, printers for the one or more users to receive data. In another example, the input/output circuitry 204 may include various output circuitry such as a display.

In some embodiments, the server 104 may further comprise the communication circuitry 206. The communication circuitry 206 may allow the server 104 to exchange data or information with the user device 106, other systems or apparatuses. Further, the communication circuitry 206 may include network interfaces, protocols, and software modules responsible for sending and receiving data or information from the user device 106. In some embodiments, the communication circuitry 206 may include Ethernet ports, Wi-Fi adapters, or communication protocols like HTTP or MQTT for connecting with other systems. The communication circuitry 206 may further include components such as communication modules (e.g., Wi-Fi, Ethernet, cellular), transceivers, antennas, and protocols (e.g., TCP/IP, MQTT, SNMP) for exchanging data with the user device 106 and the other systems. The communication circuitry 206 may allow the server 104 to stay up-to-date.

It will be apparent to one skilled in the art the above-mentioned components of the server 104 have been provided only for illustration purposes, without departing from the scope of the disclosure.

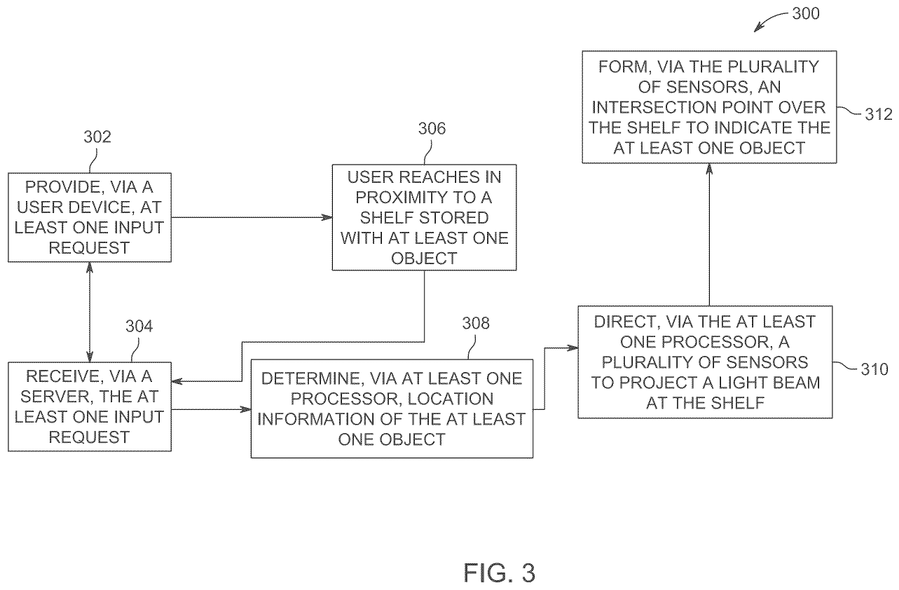

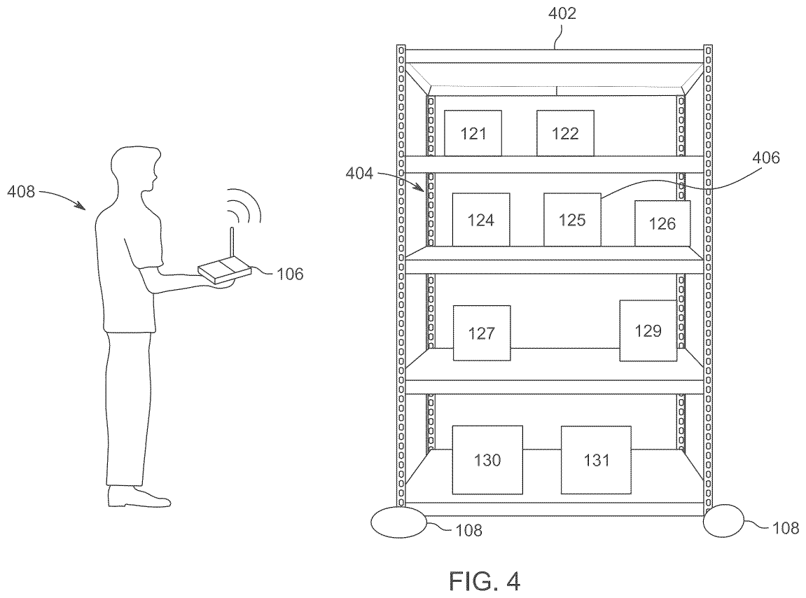

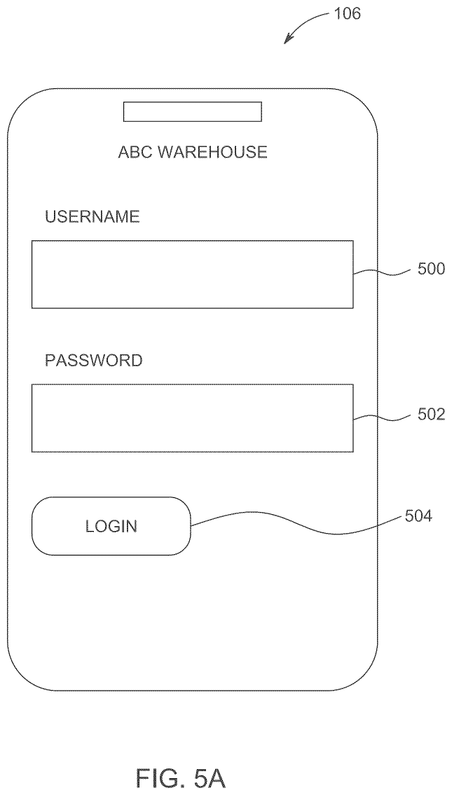

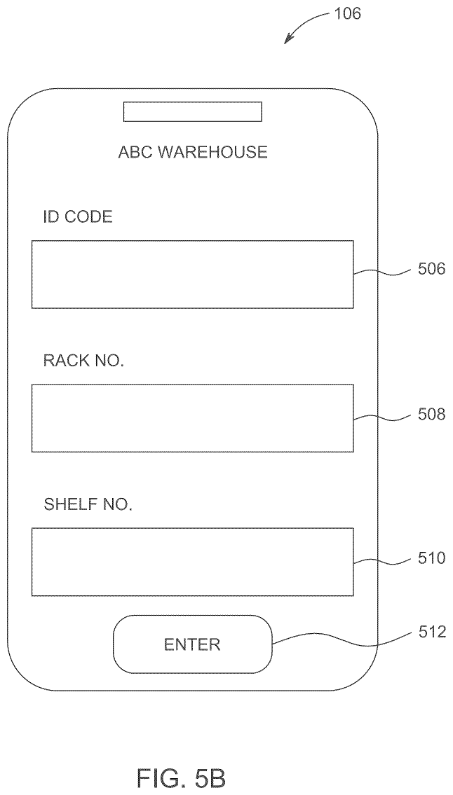

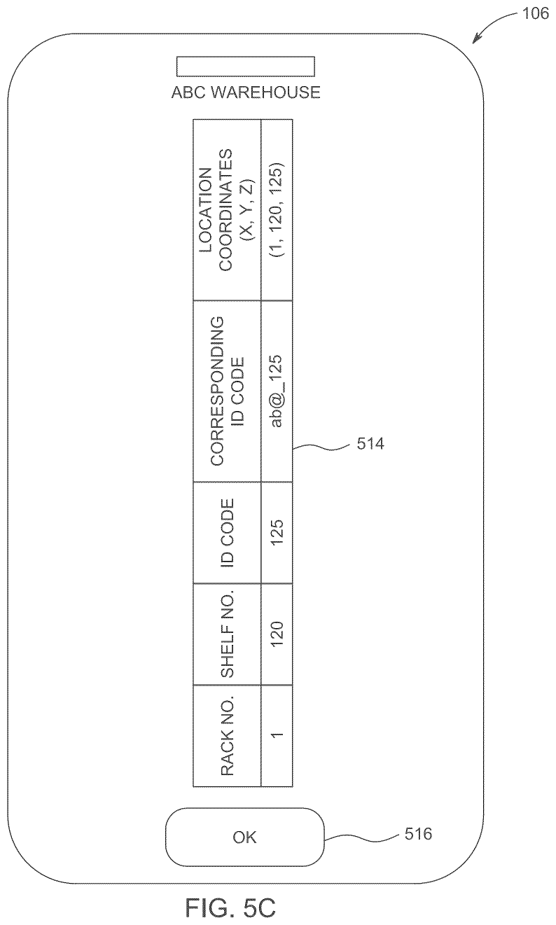

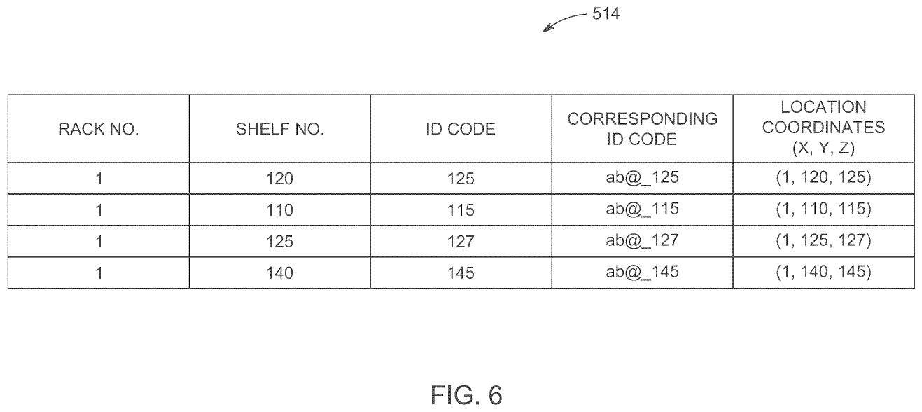

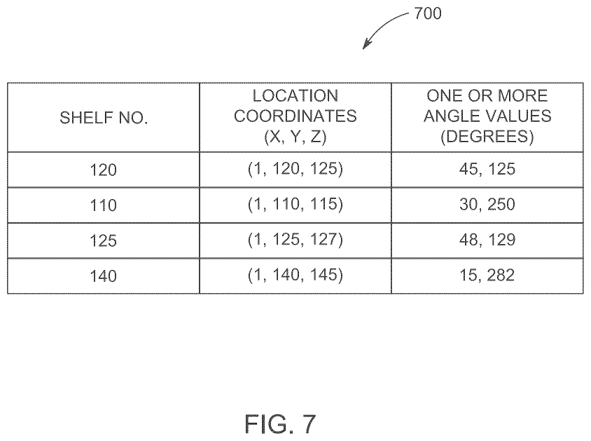

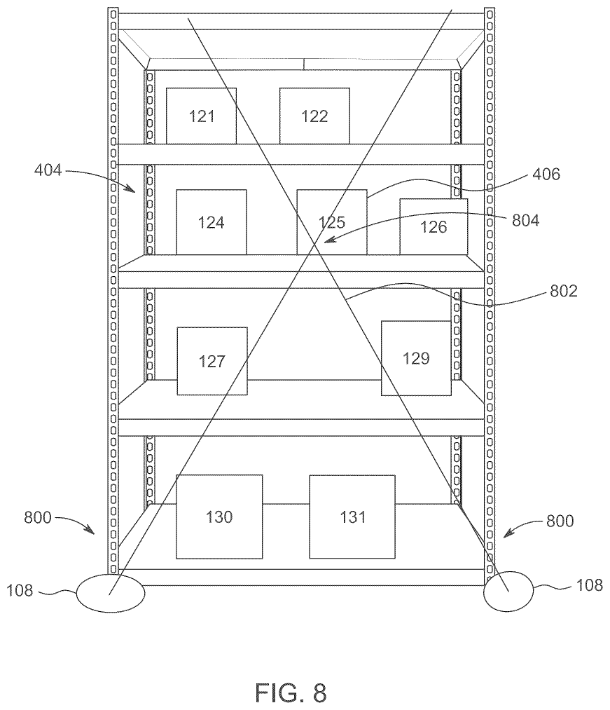

FIG. 3 illustrates a block diagram 300 showing an operation of the system 100 for assisting the user for managing goods within the warehouse, in accordance with an example embodiment of the present disclosure. FIG. 4 illustrates a working scenario of a user 408 interacting with the system 100 via the user device 106, in accordance with an example embodiment of the present disclosure. FIGS. 5A-5C illustrate a front view of the user device 106 installed with the application, in accordance with an example embodiment of the present disclosure. FIG. 6 illustrates a table showing a database 514, in accordance with an example embodiment of the present disclosure. FIG. 7 illustrates another table 700 showing the one or more angle values of the corresponding location coordinates, in accordance with an example embodiment of the present disclosure. FIG. 8 illustrates an exemplary scenario of an intersection point 804 of a light beam 802 projected by the plurality of sensors 108 over at least one object 406, in accordance with an example embodiment of the present disclosure. FIGS. 3-8 are described in conjunction with FIGS. 1 and 2.

At operation 302, the user device 106 may be accessed by the user 408 to provide the at least one input request. In some embodiments, the at least one input request may comprise the at least an ID code corresponding to the at least one object 406 to be picked from at least one rack 402 or placed over the at least one rack 402. Further, the user device 106 may comprise at least one of a mobile phone, tablet, laptop, etc. Further, the user device 106 may be installed with the application that may provide the software platform to the user 408 to provide the at least one input request. Further, the ID code may comprise at least one of 124, 125, 126, etc.

For example, a warehouse is contained with a plurality of racks. Further, the at least one rack 402 from the plurality of racks comprises a plurality of shelves 404. Further, each shelf from the plurality of shelves 404 stores the at least one object 406. Further, the user device 106 may be accessed by the user 408 to feed at least one input to pick the at least one object 406 from the at least one rack 402 from the plurality of racks. In one example, the at least one input is 125.

As illustrated in FIG. 4, the user 408 may be configured to access the user device 106 to provide the at least one input. In some embodiments, the server 104 may indicate the user 408 from where the at least one object 406 is to be picked or placed. In some embodiments, the user device 106 may include personal computers such as desktop computers, laptop computers, tablets, smartphones, or mobile devices. In some embodiments, the user device 106 may equip with the application designed to interact with user 408. The user device 106 may be installed with the application that facilitate the user 408 to enter the ID code of the at least one object 406. The user device 106 may receive the at least one input request from the user 408. The at least one input request may include the ID code for the at least one object 406 to be picked or placed within the warehouse. The application installed on the user device 106 may serve as a user-friendly interface through which the user 408 may access the system functionalities, receive the at least one input request from the user 408, and receive real-time updates on picking the at least one object 406 from the at least one rack 402 or placing the at least one object 406 over the at least one rack 402. In some embodiments, the server 104 may be communicatively coupled to the user device 106 having the application.

Further, each shelf of the at least one rack 402 may be configured to contain the plurality of objects. In some embodiments, each of the at least one object 406 may be associated with an ID code. In some embodiments, each shelf from the plurality of shelves 404 of the at least one rack 402 may have specific locations coordinates. For example, the at least one rack 402 (as illustrated in FIG. 4) may comprise the plurality of shelves 404 (i.e. 5 shelves). Further, each shelf may be contained with the plurality of objects each having a corresponding ID codes (i.e. 121, 122, 124, 125, etc.).

As illustrated in FIG. 5A, the user device 106 may be installed with the application. Firstly, before providing the at least one input request, the user 408 may be required to input one or more credentials into the application to login to the application. Further, the application may comprise one or more input fields. Further, the one or more input field may be accessed by the user 408 to input the one or more credentials. In some embodiments, the one or more input credentials may comprise at least one of a username (illustrated by 500) and password (illustrated by 502). Further, the application may further comprise a virtual button. Further, a virtual button (illustrated by 504) may be accessed by the user 408 to generate a login request.

Further, the user device 106 may be communicatively coupled to the server 104 via the network 102. Further, the user device 106 may be configured to send the login request along with the one or more input credentials to the server 104. Further, the server 104 may be configured to compare the one or more input credentials to a data pre-saved into the memory 202. Further, the application may be configured to redirect the user 408 to an another page associated with the application, based at least on the comparison.

As illustrated in FIG. 5B, another page may comprise one or more input fields. Further, the one or more input fields may be accessed by the user 408 to provide the at least one input request. Further, the at least one input request may be provided by the user 408 by entering one or more details into the one or more input fields of the another page. Further, the one or more details may comprise an ID code 506 corresponding to the at least one object 406, a rack no. 508 corresponding to the at least one object 406, and a shelf no. 510 corresponding to the at least one object 406. In some embodiments, the ID code 506 may also be referred as package ID code. Further, the another page may comprise another virtual button 512. Further, the another virtual button 512 may be pressed by the user 408 upon successfully entering the one or more details into the one or more input fields.

At operation 304, the server 104 may be configured to receive the at least one input request from the user device 106. Further, the server 104 may comprise the at least one processor 200, the memory 202, the input/output circuitry 204, and the communication circuitry 206. Further, the server 104 may be configured to access the database 514 from the memory 202. In some embodiments, upon accessing the database 514, the server 104 may be configured to direct the user 408 to another page of the application to display the database 514 (as illustrated in FIG. 5C). Further, the database 514 may comprise the location information related to each of the at least one object 406 stored within each shelf from the plurality of shelves 404 of the at least one rack 402. In one example, the database 514 may be represented in a tabular form. Further, the database 514 may comprise data associated with the ID code 506 corresponding to the at least one object 406, the rack no. 508 corresponding to the at least one object 406, and the shelf no. 510 corresponding to the at least one object 406. The database 514 further comprise the corresponding ID code of the at least one object 406 stored within the memory 202, and the location coordinates corresponding to the at least one object 406.

At operation 306, the user 408 may reach in proximity to the shelf that may be stored with the at least one object 406 based on the displayed database 514. In some embodiments, the user 408 may be configured to navigate towards the shelf for the at least one object 406 based on the displayed database 514 over the user device 106 for the user 408. In some embodiments, the application may comprise another virtual button 516 (as illustrated in FIG. 5C). Further, the another virtual button 516 may be pressed by the user 408 upon reaching in proximity to the shelf. Further, the server 104 may comprise the at least one processor 200. Further, the user device 106 may be communicatively coupled with the server 104 through the network 102. For example, based at least on the at least one input given by the user 408, the application installed within the user device 106 may be configured to show the shelf number. corresponding to the at least one object 406 from the plurality of shelves 404 to the user 408 or a rack number, corresponding to the at least one object 406. The user 408 may thereby reach towards the at least one rack 402 and the shelf from the plurality of shelves 404 having the at least one object 406.

At operation 308, the at least one processor 200 may be configured to determine location information of the at least one object 406 to be picked from the at least one rack 402 or placed over the at least one rack 402. Further, the at least one processor 200 may be configured to compare the received at least one input request having the ID code with the corresponding ID code of the at least one object 406 saved within the memory 202 to determine the location information of the at least one object 406. Further, the corresponding ID code may be stored within the database 514. Further, the location information may comprise location coordinates and the shelf number related to the shelf from the plurality of shelves 404 of the at least one rack 402 where the at least one object 406 to be picked or placed.

As illustrated in FIG. 6 the table may be configured to illustrate the database 514 associated with the warehouse. In some embodiments, the database 514 may comprise one or more ID codes associated with each of the plurality of objects along with location information of each of the plurality of objects. In some embodiments, the table comprises a plurality of columns. Further, the plurality of columns may comprise rack no., shelf no., ID code, corresponding ID code, and location coordinates.

For example, the at least one processor 200 is configured to receive the at least one input request (i.e. 125). Further, the at least one processor 200 is configured to compare the at least one input request to a corresponding ID code (i.e. ab@_125). Further, the at least one processor 200 is configured to determine location information the at least one object 406 to be picked from the at least one rack 402 or placed over the at least one rack 402, based at least on the comparison. Further, based on the comparison, the location information may be determined by the at least one processor 200. In some embodiments, the location information comprises location coordinates (1, 120, 125) of the shelf. Further, based on the location information, the at least one processor 200 may be configured to determine the one or more angle values corresponding to the determined location coordinates of the shelf of the at least one rack 402 from where the at least one object 406 to be picked or placed, using the plurality of sensors 108. In some embodiments, the one or more angle values may correspond to the angle at which the plurality of sensors 108 are to be directed.

At operation 310, the at least one processor 200 may be configured to direct the plurality of sensors 108 placed at the one or more positions of the at least one rack 402 based on the determined one or more angle values (as illustrated in FIG. 4). Further, each of the plurality of sensors 108 may be configured to project the light beam 802 at the shelf of the at least one rack 402 from where the at least one object 406 is to be picked or placed, based at least on the determined location information. Further, based at least on the determined one or more angle values, the at least one processor 200 may be configured to actuate the at least one actuator, to rotate each of the plurality of sensors 108 to project the light beam 802 over the shelf of the at least one rack 402 from where the at least one object 406 to be picked or placed. Further, the determined one or more angle values may comprise (48 degrees, 129 degrees).

For example, the at least one processor 200 is communicatively coupled to a plurality of sensors 108 installed at one or more positions on the at least one rack 402. Further, the at least one processor 200 is configured to direct the plurality of sensors 108 to project the light beam 802 over the at least one object 406 placed within the at least one rack 402. Further, the at least one processor 200 is configured to determine one or more angle values corresponding to the location coordinates determined by the at least one processor 200. Further, at least one actuator coupled between the plurality of sensors 108 and the at least one rack 402 to rotate the plurality of sensors 108 in one or more directions.

As illustrated in FIG. 7 the table 700 may be configured to illustrate the one or more angle values associated with the location coordinates of the plurality of shelves 404. In some embodiments, the table 700 comprises a plurality of columns. Further, the plurality of columns may comprise shelf no. (i.e. 120, 110, 125, 140), the location coordinates (i.e. (1, 120, 125), (1, 110, 115), (1, 125, 127), (1, 140, 145)), and the one or more angle values (i.e. (45, 125) degrees, (30, 250) degrees, (48, 129) degrees, (15, 282) degrees).

At operation 312, the plurality of sensors 108 may be configured to form the intersection point 804 over the shelf of the at least one rack 402 by projecting the light beam 802 over the at least one object 406 to indicate the user 408 from where the at least one object 406 to be picked or placed. Further, the at least one actuator installed between each of the plurality of sensors 108 and the at least one rack 402 may be configured to provide movement to the plurality of sensors 108 in the clockwise or anticlockwise direction to form the interaction point over the shelf.

For example, the at least one processor 200 is configured to direct the at least one actuator to rotate each of the plurality of sensors 108 in the one or more directions to form an interaction point over the shelf of the at least one rack 402 by projecting the light beam 802 over the at least one object 406 (i.e. 125) to indicate the user 408 from where the at least one object 406 to be picked or placed.

As illustrated in FIG. 8, the at least one rack 402 may comprise the plurality of shelves 404. Further, each shelf may be stored with the plurality of objects (i.e. 121, 122, 124, 125, 127, etc.). In some embodiments, the at least one rack 402 may comprise a plurality of platforms that may be configured to enable placement of each of the at least one object 406. Further, the at least one rack 402 may comprise a plurality of supporting arms that may be configured to provide support to the at least one rack 402 over fixed surfaces. In some embodiments, each of the plurality of shelves 404 may be constructed with a dimension that may be configured to store each of the at least one object 406. Further, the dimension of each of the plurality of shelves 404 may be selected such that each of the at least one object 406 of various sizes may be contained within the at least one rack 402.

In some embodiments, the plurality of sensors 108 may be installed at the one or more positions. Further, the one or more positions may correspond to at least bottom corners 800 of the at least one rack 402 (as illustrated in FIG. 8). Further, the plurality of sensors 108 may include the at least one of a laser sensor, a light emitting diode (LED) sensor, or a projector sensor. Further, the plurality of sensors 108 may be directed by the at least one processor 200 to rotate and project the light beam 802 onto the plurality of shelves 404 where the at least one object 406 may be placed.

In one example, the user 408 may be required to pick the at least one object 406 labeled with ID code 125 from one of the plurality of shelves 404 of the at least one rack 402 within the warehouse. Further, the shelf that be contained with the at least one object 406 labeled with the ID code 125 may correspond to 2. Further, the user 408 may access the user device 106 to input the at least one request by entering the ID code (125), rack no. (1), and the shelf no. (2). Further, the at least one processor 200 of the server 104 may be configured to receive the at least one input request. Further, the at least one processor 200 may be configured to compare the at least one input request with a corresponding ID code (ab@_125). Further, the at least one processor 200 may be configured to determine location information of the at least one object 406 labeled with the ID code 125. Further, the location information may correspond to location coordinates. Further, the at least one processor 200 may be configured to direct the plurality of sensors 108 placed at the at least bottom corners 800 of the at least one rack 402 to rotate and project the light beam 802 onto the shelf of the at least one rack 402 where the at least one object 406 to be picked.

In some embodiments, the plurality of sensors 108 may comprise a first sensor and a second sensor. In some embodiments, the first sensor from the plurality of sensors 108 may be configured to rotate in a clockwise direction. In some embodiments, the second sensor from the plurality of sensors 108 may be configured to rotate in an anticlockwise direction. In some embodiments, the rotation of the plurality of sensors 108 may be regulated by the server 104 through the at least one actuator. The at least one actuator may control the rotation of the plurality of sensors 108 in the clockwise and anticlockwise direction.

In some embodiments, the plurality of sensors 108 may project the light beam 802 upon rotating in the clockwise direction and the anticlockwise direction. In some embodiments, the light beam 802 projected by each of the plurality of sensors 108 may intersect at an interaction point on at least one of the plurality of shelves 404 (i.e. 2). In some embodiments, the intersection point 804 of the light beam 802 may indicate an exact location of the at least one object 406 corresponding to the ID code 125. In some embodiments, the at least one processor 200 may be configured to calculate the one or more angle values for rotation of the plurality of sensors 108 based at least on the location coordinates of at least one of the plurality of shelves 404 and the position of the plurality of sensors 108. Further, the intersection point 804 of the light beam 802 may guide the user 408 to locate the at least one object 406 corresponding to the ID code 125 on the shelf number 2.

In another example, when the user 408 may be required to pick the at least one object 406 labeled with ID code 129 from one of the plurality of shelves 404 of the at least one rack 402 within the warehouse. Further, the shelf that be contained with the at least one object 406 labeled with the ID code 129 may correspond to 3. Further, the user 408 may access the user device 106 to input the at least one request by entering the ID code (129), the at least one rack no. (1), and the shelf no. (3). Further, the at least one processor 200 of the server 104 may be configured to receive the at least one input request. Further, the at least one processor 200 may be configured to compare the at least one input request with a corresponding ID code (ab@_129). Further, the at least one processor 200 may be configured to determine location information of the at least one object 406 labeled with the ID code 129. Further, the location information may correspond to location coordinates. Further, the at least one processor 200 may be configured to direct the plurality of sensors 108 placed at the at least bottom corners 800 of the at least one rack 402 to rotate and project the light beam 802 onto the shelf of the at least one rack 402 where the at least one object 406 to be picked.

In some embodiments, the plurality of sensors 108 may comprise a first sensor and a second sensor. In some embodiments, the first sensor from the plurality of sensors 108 may be configured to rotate in a clockwise direction. In some embodiments, the second sensor from the plurality of sensors 108 may be configured to rotate in an anticlockwise direction. In some embodiments, the rotation of the plurality of sensors 108 may be regulated by the server 104 through the at least one actuator. The at least one actuator may control the rotation of the plurality of sensors 108 in the clockwise and anticlockwise direction.

In some embodiments, the plurality of sensors 108 may emit the light beam 802 upon rotating in the clockwise direction and the anticlockwise direction. In some embodiments, the light beam 802 projected by each of the plurality of sensors 108 may intersect at an interaction point on at least one of the plurality of shelves 404 (i.e. 3). In some embodiments, the intersection point 804 of the light beam 802 may indicate an exact location of the at least one object 406 corresponding to the ID code 129. In some embodiments, the at least one processor 200 may be configured to calculate the one or more angles for rotation of the plurality of sensors 108 based at least on the location coordinates of at least one of the plurality of shelves 404 and the position of the plurality of sensors 108. Further, the intersection point 804 of the light beam 802 may guide the user 408 to locate the at least one object 406 corresponding to the ID code 129 on the shelf number 3.

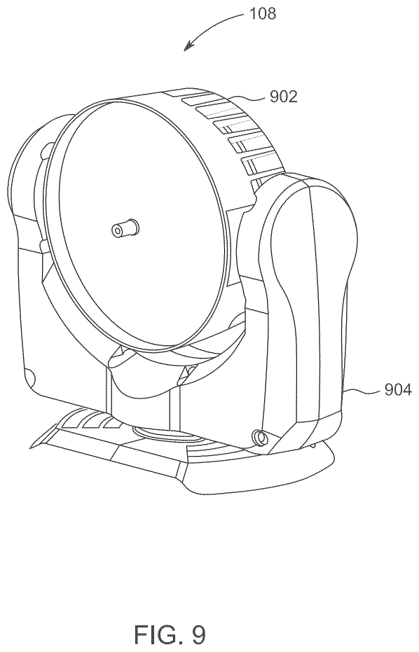

FIG. 9 illustrates a perspective view of at least one sensor from the plurality of sensors 108, in accordance with an example embodiment of the present disclosure. FIG. 9 is described in conjunction with FIGS. 1-8.

In some example embodiment, at least one sensor 108 from the plurality of sensors 108 may comprise a housing 902. Further, the housing 902 may be configured to encase a plurality of electronic components and a plurality of electrical components associated with the plurality of sensors 108. In some embodiments, the housing 902 may be crafted with a shape that may include but not limited to a circular shape, rectangular shape, an oval shape, etc. Further, the housing 902 may be constructed with a material that may include but not limited to metal, non-metal, alloy, etc.

In some embodiments, the plurality of sensors 108 may comprise at least one of the laser sensor, a light emitting diode (LED) sensor, or a projector sensor. Further, the at least one sensor 108 from the plurality of sensors 108 may be configured to project the light beam 802. Further, the at least one sensor 108 from the plurality of sensors 108 may comprise at least one light source, and an optical arrangement. In some embodiments, the light source may be configured to emit one or more light rays upon supplied with a predefined threshold voltage. Further, the optical arrangement may correspond to one or more lenses. In some embodiments, the optical arrangement may be configured to converge the one or more light rays to provide the light beam 802.

In some embodiments, the at least one sensor 108 from the plurality of sensors 108 may be operationally coupled with at least one actuator 904. Further, the at least one actuator 904 may be configured to provide a rotational movement to the plurality of sensors 108 in one or more directions. In some embodiments, the one or more directions may comprise the anticlockwise direction and the clockwise direction. Further, the at least one actuator 904 may comprise at least one of a motorized joint. In some embodiments, the at least one actuator 904 may comprise at least one of a motorized universal joint, a motorized pin joint, etc.

In some embodiments, the at least one actuator 904 may be operationally coupled with the housing 902 of the plurality of sensors 108. Further, the at least one actuator 904 may be communicatively coupled with the at least one processor 200 of the server 104. Further, the at least one processor 200 may be configured to direct the at least one actuator 904 to move the plurality of sensors 108 in the one or more directions, based at least on the determined one or more angle values. In at least one example, the at least one processor 200 may be configured to direct the at least one actuator 904 to move the plurality of sensors 108 in the anticlockwise direction. In another example, the at least one processor 200 may be configured to direct the at least one actuator 904 to move the plurality of sensors 108 in the clockwise direction.

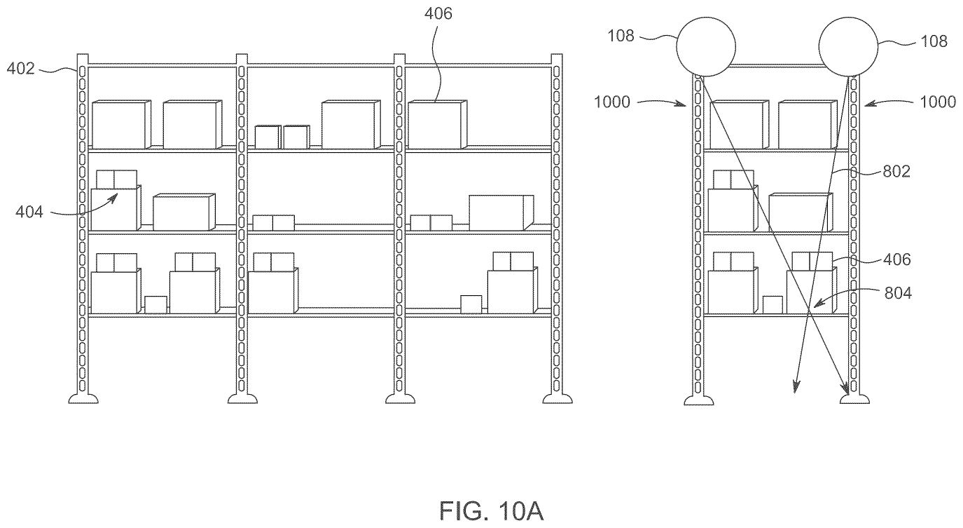

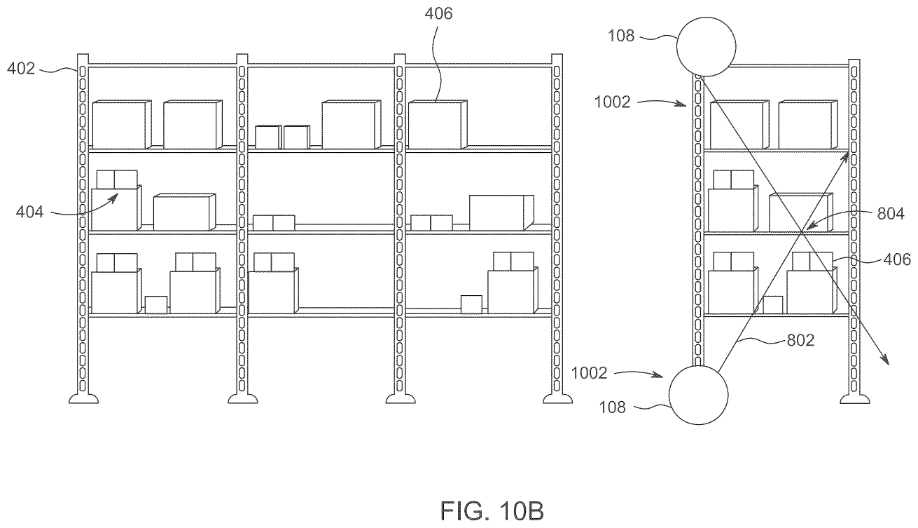

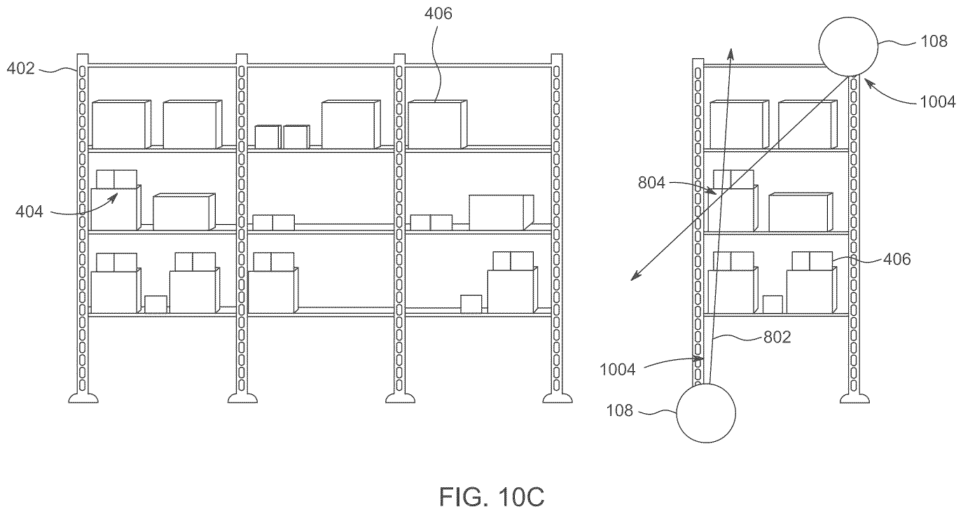

FIG. 10A illustrates a front view of the at least one rack 402 installed with the plurality of sensors 108 in at least top corners 1000 of the at least one rack 402, in accordance with an example embodiment of the present disclosure. FIG. 10A is described in conjunction with FIGS. 1-9.

In some embodiments, the plurality of sensors 108 may be installed at the one or more positions of the at least one rack 402. Further, the one or more positions may correspond to the at least top corners 1000 of the at least one rack 402. In some embodiments, the plurality of sensors 108 may be configured to project the light beam 802 over the at least one object 406 from the at least top corners 1000 of the at least one rack 402. In some embodiments, the plurality of sensors 108 may comprise the first sensor and the second sensor. In some embodiments, the first sensor from the plurality of sensors 108 may be configured to rotate in the clockwise direction or the anticlockwise direction. In some embodiments, the second sensor from the plurality of sensors 108 may be configured to rotate in the anticlockwise direction or the clockwise direction. In some embodiments, the rotation of the plurality of sensors 108 may be regulated by the server 104 through the at least one actuator 904. The at least one actuator 904 may control the rotation of the plurality of sensors 108 in the clockwise and anticlockwise direction.

In some embodiments, the plurality of sensors 108 may project the light beam 802 upon rotating in the clockwise direction and the anticlockwise direction. In some embodiments, the light beam 802 projected by each of the plurality of sensors 108 may intersect at an interaction point on at least one of the plurality of shelves 404 (as illustrated in FIG. 10A). In some embodiments, the intersection point 804 of the light beam 802 may indicate an exact location of the at least one object 406. In some embodiments, the at least one processor 200 may be configured to calculate the one or more angle values for rotation of the plurality of sensors 108 based at least on the location coordinates of at least one of the plurality of shelves 404 and the position of the plurality of sensors 108. Further, the intersection point 804 of the light beam 802 may guide the user 408 to locate the at least one object 406.

FIG. 10B illustrates another front view of the at least one rack 402 installed with the plurality of sensors 108 in at least top and bottom sides 1002 of the at least one rack 402, in accordance with an example embodiment of the present disclosure. FIG. 10B is described in conjunction with FIGS. 1-10A.

In some embodiments, the plurality of sensors 108 may be installed at the one or more positions of the at least one rack 402. Further, the one or more positions may correspond to the at least top and bottom sides 1002 of the at least one rack 402. In some embodiments, the plurality of sensors 108 may be configured to project the light beam 802 over the at least one object 406 from the at least top and bottom sides 1002 of the at least one rack 402. In some embodiments, the plurality of sensors 108 may comprise the first sensor and the second sensor. In some embodiments, the first sensor from the plurality of sensors 108 may be installed at the at least top side of the at least one rack 402. Further, the second sensor from the plurality of sensors 108 may be installed at least at least bottom side of the at least one rack 402. In some embodiments, the first sensor from the plurality of sensors 108 may be configured to rotate in the clockwise direction or the anticlockwise direction. In some embodiments, the second sensor from the plurality of sensors 108 may be configured to rotate in the anticlockwise direction or the clockwise direction. In some embodiments, the rotation of the plurality of sensors 108 may be regulated by the server 104 through the at least one actuator 904. The at least one actuator 904 may control the rotation of the plurality of sensors 108 in the clockwise and anticlockwise direction.

In some embodiments, the plurality of sensors 108 may emit the light beam 802 upon rotating in the clockwise direction and the anticlockwise direction. In some embodiments, the light beam 802 projected by each of the plurality of sensors 108 may intersect at an interaction point on at least one of the plurality of shelves 404 (as illustrated in FIG. 10B). In some embodiments, the intersection point 804 of the light beam 802 may indicate an exact location of the at least one object 406. In some embodiments, the at least one processor 200 may be configured to calculate the one or more angle values for rotation of the plurality of sensors 108 based at least on the location coordinates of at least one of the plurality of shelves 404 and the position of the plurality of sensors 108. Further, the intersection point 804 of the light beam 802 may guide the user 408 to locate the at least one object 406.

FIG. 10C illustrates another front view of the at least one rack 402 installed with the plurality of sensors 108 in at least diagonal corners 1004 of the at least one rack 402, in accordance with an example embodiment of the present disclosure. FIG. 10C is described in conjunction with FIGS. 1-10B.

In some embodiments, the plurality of sensors 108 may be installed at the one or more positions of the at least one rack 402. Further, the one or more positions may correspond to the at least diagonal corners 1004 of the at least one rack 402. In some embodiments, the plurality of sensors 108 may be configured to project the light beam 802 over the at least one object 406 from the at least diagonal corners 1004 of the at least one rack 402. In some embodiments, the plurality of sensors 108 may comprise the first sensor and the second sensor. In some embodiments, the first sensor from the plurality of sensors 108 may be installed at least one of the bottom corner of the at least one rack 402. Further, the second sensor from the plurality of sensors 108 may be installed at least one of the top corner of the at least one rack 402. In some embodiments, the first sensor from the plurality of sensors 108 may be configured to rotate in the clockwise direction or the anticlockwise direction. In some embodiments, the second sensor from the plurality of sensors 108 may be configured to rotate in the anticlockwise direction or the clockwise direction. In some embodiments, the rotation of the plurality of sensors 108 may be regulated by the server 104 through the at least one actuator 904. The at least one actuator 904 may control the rotation of the plurality of sensors 108 in the clockwise and anticlockwise direction.

In some embodiments, the plurality of sensors 108 may emit the light beam 802 upon rotating in the clockwise direction and the anticlockwise direction. In some embodiments, the light beam 802 projected by each of the plurality of sensors 108 may intersect at an interaction point on at least one of the plurality of shelves 404 (as illustrated in FIG. 10C). In some embodiments, the intersection point 804 of the light beam 802 may indicate an exact location of the at least one object 406. In some embodiments, the at least one processor 200 may be configured to calculate the one or more angle values for rotation of the plurality of sensors 108 based at least on the location coordinates of at least one of the plurality of shelves 404 and the position of the plurality of sensors 108. Further, the intersection point 804 of the light beam 802 may guide the user 408 to locate the at least one object 406.

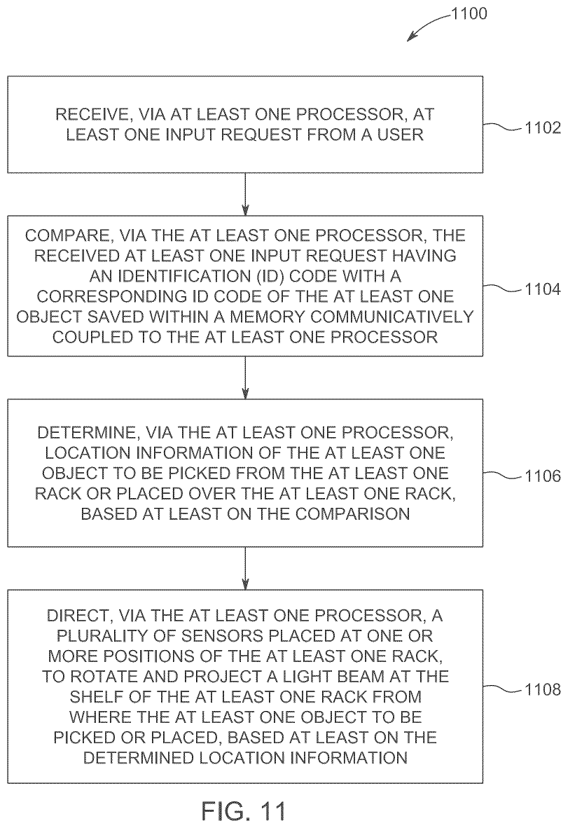

FIG. 11 illustrates a flowchart showing a method 1100 for assisting the user 408 for managing goods within the warehouse, in accordance with an example embodiment of the present disclosure. FIG. 11 is described in conjunction with FIGS. 1-10C.

At operation 1102, the at least one processor 200 may be configured to receive the at least one input request from the user 408. Further, the at least one input request may comprise the identification (ID) code corresponding to the at least one object 406 to be picked from the at least one rack 402 or placed over the at least one rack 402. For example, the at least one input request may correspond to the ID code. The at least one input request may further correspond to the at least one object 406 corresponding to the ID code. Further, the user device 106 may be accessed by the user 408 to provide the at least one input request. Further, the user device 106 may be communicatively coupled with the server 104 through the network 102. Further, the user device 106 may be installed with the application that may provide the software platform to the user 408 to provide the at least one input request. In at least one example, the at least one input request may comprise the ID code corresponding to the at least one object 406, while picking the at least one object 406 from the at least one rack 402. In another example, the at least one input request may comprise a shelf ID code or a rack ID code, while placing the at least object into the at least one rack 402. In another example, the at least one input request may correspond to a unique ID code having one or more unique characters.

In one example, a warehouse is contained with a plurality of racks. Further, each of the plurality of racks comprises the plurality of shelves 404. Further, each shelf from the plurality of shelves 404 stores a plurality of objects. Further, a user device 106 is accessed by a user 408 to input at least one input to pick the at least one object 406 from the at least one rack 402 from the plurality of racks. Further, the at least one input is 130. Further, the shelf that be contained with the at least one object 406 labeled with the ID code 130 may correspond to 4. Further, the user 408 may access the user device 106 to input the at least one request by entering the ID code (130), the rack no. (1), and the shelf no. (4). Further, the at least one processor 200 of the server 104 may be configured to receive the at least one input request.

In another example, an inventory is contained with a plurality of racks. Further, each of the plurality of racks comprises the plurality of shelves 404. Further, each shelf from the plurality of shelves 404 stores a plurality of objects. Further, a user device 106 is accessed by a user 408 to input at least one input to pick the at least one object 406 from the at least one rack 402 from the plurality of racks. Further, the at least one input is 121. Further, the shelf that be contained with the at least one object 406 labeled with the ID code 121 may correspond to 1. Further, the user 408 may access the user device 106 to input the at least one request by entering the ID code (121), the rack no. (1), and the shelf no. (1). Further, the at least one processor 200 of the server 104 may be configured to receive the at least one input request.

At operation 1104, the at least one processor 200 may be configured to compare the received at least one input request by the user 408 having the ID code with the corresponding ID code of the at least one object 406. Further, the corresponding ID code of the at least one object 406 may be pre-saved within the memory 202. Further, the memory 202 may be configured to store the database 514 associated with an inventory record of the warehouse. Further, the database 514 may comprise the plurality of ID code(s) corresponding. In some embodiments, the server 104 may examine each of the at least one input request to identify matching ID codes among the stored data. Further, the server 104 may be configured to compare the received ID code with the corresponding ID code by the at least one synchronous approach.

In one example, the at least one processor 200 is configured to compare the at least one input with a corresponding ID code of the at least one object 406. Further, the at least one input is the ID code (130), the rack no. (1), and the shelf no. (4). Further, the corresponding ID code may comprise at least one of a (ab@_121), (ab@_124), (ab@_126), (ab@128), (ab@_130), etc.

In another example, the at least one processor 200 is configured to compare the at least one input with a corresponding ID code of the at least one object 406. Further, the at least one input is the ID code (121), the rack no. (1), and the shelf no. (1). Further, the corresponding ID code may comprise at least one of a (ab@_121), (ab@_124), (ab@_126), (ab@128), (ab@_130), etc.

At operation 1106, the at least one processor 200 may be configured to determine location information of the at least one object 406 to be picked from the at least one rack 402 or placed over the at least one rack 402, based at least on the comparison. Further, the location information may comprise location coordinates and the shelf number related to the shelf from the plurality of shelves 404 of the at least one rack 402 where the at least one object 406 to be picked or placed. Further, the location information may be saved within the memory 202 or the database 514. Further, the at least one processor 200 may be configured to determine the one or more angle values corresponding to the determined location coordinates of the shelf of the at least one rack 402 from where the at least one object 406 to be picked or placed.

In one example, the at least one processor 200 is configured to determine location information of the at least one object 406 labeled with the ID code 130. Further, the location information may correspond to location coordinates. Further, the location coordinates correspond to (1, 4, 130). In another example, the at least one processor 200 is configured to determine location information of the at least one object 406 labeled with the ID code 121.Further, the location information may correspond to location coordinates. Further, the location coordinates correspond to (1, 1,121).

At operation 1108, the at least one processor 200 may be configured to direct the plurality of sensors 108 placed at the one or more positions of the at least one rack 402, to rotate and project the light beam 802 at the shelf of the at least one rack 402 from where the at least one object 406 to be picked or placed, based at least on the determined location information. Further, the light beam 802 from the plurality of sensors 108 forms the intersection point 804 over the shelf of the at least one rack 402 to indicate the user 408 from where the at least one object 406 to be picked or placed. Further, the one or more positions of the at least one rack 402 comprises at least one of the placement of each of the plurality of sensors 108 in the at least top corners 1000 of the at least one rack 402, in the at least top and bottom sides 1002 of the at least one rack 402, or in the at least diagonal corners 1004 of the at least one rack 402. Further, the at least one processor 200 may be configured to actuate the at least one actuator 904 based at least on the determined one or more angle values, to rotate and project the light beam 802 over the shelf of the at least one rack 402 from where the at least one object 406 to be picked or placed.

In one example, the at least one processor 200 is configured to direct the plurality of sensors 108 placed at least on top corners of the at least one rack 402 to rotate and project the light beam 802 onto the shelf of the at least one rack 402 where the at least one object 406 labeled with the ID code 130 to be picked. Further, the plurality of sensors 108 may comprise a first sensor and a second sensor. In some embodiments, the first sensor from the plurality of sensors 108 may be configured to rotate in a clockwise direction. In some embodiments, the second sensor from the plurality of sensors 108 may be configured to rotate in an anticlockwise direction. In some embodiments, the rotation of the plurality of sensors 108 may be regulated by the server 104 through at least one actuator 904. The at least one actuator 904 may control the rotation of the plurality of sensors 108 in the clockwise and anticlockwise direction.

Further, the plurality of sensors 108 may emit the light beam 802 upon rotating in the clockwise direction and the anticlockwise direction. In some embodiments, the light beam 802 projected by each of the plurality of sensors 108 may intersect at an interaction point on at least one of the plurality of shelves 404 (i.e. 4). In some embodiments, the intersection point 804 of the light beam 802 may indicate an exact location of the at least one object 406 corresponding to the ID code 130. In some embodiments, the at least one processor 200 may be configured to calculate the one or more angle values for rotation of the plurality of sensors 108 based at least on the location coordinates of at least one of the plurality of shelves 404 and the position of the plurality of sensors 108. Further, the intersection point 804 of the light beam 802 may guide the user 408 to locate the at least one object 406 corresponding to the ID code 130 on the shelf number 4.

In another example, the at least one processor 200 is configured to direct the plurality of sensors 108 placed at least bottom corners 800 of the at least one rack 402 to rotate and project the light beam 802 onto the shelf of the at least one rack 402 where the at least one object 406 labeled with the ID code 121 to be picked. Further, the plurality of sensors 108 may comprise a first sensor and a second sensor. In some embodiments, the first sensor from the plurality of sensors 108 may be configured to rotate in a clockwise direction. In some embodiments, the second sensor from the plurality of sensors 108 may be configured to rotate in an anticlockwise direction. In some embodiments, the rotation of the plurality of sensors 108 may be regulated by the server 104 through at least one actuator 904. The at least one actuator 904 may control the rotation of the plurality of sensors 108 in the clockwise and anticlockwise direction.

Further, the plurality of sensors 108 may emit the light beam 802 upon rotating in the clockwise direction and the anticlockwise direction. In some embodiments, the light beam 802 projected by each of the plurality of sensors 108 may intersect at an interaction point on at least one of the plurality of shelves 404 (i.e. 1). In some embodiments, the intersection point 804 of the light beam 802 may indicate an exact location of the at least one object 406 corresponding to the ID code 121. In some embodiments, the at least one processor 200 may be configured to calculate the one or more angle values for rotation of the plurality of sensors 108 based at least on the location coordinates of at least one of the plurality of shelves 404 and the position of the plurality of sensors 108. Further, the intersection point 804 of the light beam 802 may guide the user 408 to locate the at least one object 406 corresponding to the ID code 121 on the shelf number 1.

In some embodiments, a non-transitory machine-readable information storage medium comprising one or more instructions which when executed by at least one processor 200 to perform operations. In some embodiments, the at least one processor 200 may be configured to receive the at least one input request from the user 408. In some embodiments, the at least one input request comprises the ID code 506 corresponding to the at least one object 406 to be picked from the at least one rack 402 or placed over the at least one rack 402. Further, the at least one processor 200 may be configured to compare the received at least one input request having the ID code 506 with the corresponding ID code of the at least one object 406 saved within the memory 202 communicatively coupled to the at least one processor 200. Further, the at least one processor 200 may be configured to determine the location information of the at least one object 406 to be picked from the at least one rack 402 or placed over the at least one rack, based at least on the comparison.

In some embodiments, the location information comprises location coordinates and the shelf number related to the shelf from the plurality of shelves 404 of the at least one rack 402 where the at least one object 406 to be picked or placed. Further, the at least one processor 200 may be configured to direct the plurality of sensors 108 placed at the one or more positions of the at least one rack 402, to rotate and project the light beam at the shelf of the at least one rack 402 from where the at least one object to be picked or placed, based at least on the determined location information. In some embodiments, the light beam from the plurality of sensors 108 forms the intersection point over the shelf of the at least one rack 402 to indicate the user 408 from where the at least one object 406 to be picked or placed.

Further, the operations comprising directing the plurality of sensors 108 comprises at least one of a laser sensor, light emitting diode (LED) sensor, or a projector sensor, placed at one or more positions of the at least one rack 402, to rotate and project a light beam 802 at the shelf of the at least one rack 402 from where the at least one object 406 to be picked or placed, based at least on the determined location information. The light beam 802 from the plurality of sensors 108 forms an intersection point 804 over the shelf of the at least one rack 402 to indicate the user 408 from where the at least one object 406 to be picked or placed. The one or more positions of the at least one rack 402 comprises at least one of a placement of each of the plurality of sensors 108 in the at least top corners 1000 of the at least one rack 402, in the at least top and bottom sides 1002 of the at least one rack 402, or in the at least diagonal corners 1004 of the at least one rack 402.

Further, the operations comprising rotating the plurality of sensors 108 using the at least one actuator 904. The actuator is mechanically or electrically coupled to the plurality of sensors 108. Further, the operations comprising determining, one or more angle values corresponding to the determined location coordinates of the shelf of the at least one rack 402 from where the at least one object 406 to be picked or placed, using the plurality of sensors 108. Further, the operations comprising actuating the at least one actuator 904 based at least on the determined one or more angle values, to rotate and project the light beam 802 over the shelf of the at least one rack 402 from where the at least one object 406 to be picked or placed. Further, the operations comprising directing the plurality of sensors 108 placed at the one or more positions of the at least one rack 402, to rotate in anticlockwise direction and in clockwise direction using the at least one actuator 904, to form the intersection point 804 over the shelf of the at least one rack 402.

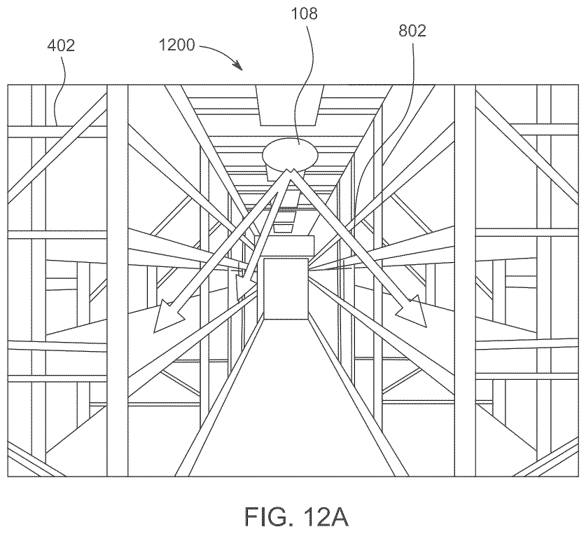

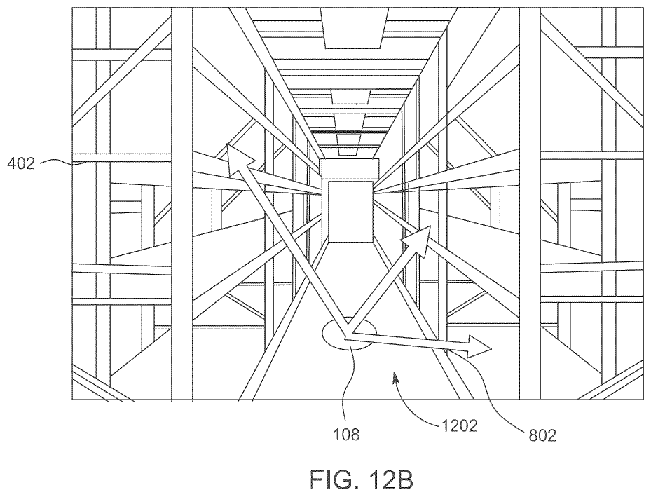

FIG. 12A illustrates a schematic view of at least one sensor installed at a roof 1200 of a warehouse, in accordance with an alternate embodiment of the present disclosure.

In some embodiments, at least one sensor from the plurality of sensors 108 may be installed at the one or more positions of inside the warehouse. Further, the one or more positions may correspond to the roof 1200 of the warehouse. In some embodiments, the at least one processor 200 may be configured to project the light beam 802 over the at least one object 406 from the roof 1200 of the warehouse. In some embodiments, the at least one sensor from the plurality of sensors 108 may be configured to rotate in the clockwise direction or the anticlockwise direction. In some embodiments, the at least one sensor from the plurality of sensors 108 may be mechanically or electrically coupled with the at least one actuator 904. Further, the rotation of the at least one sensor may be regulated by the server 104 through the at least one actuator 904. The at least one actuator 904 may control the rotation of the at least one sensor in the clockwise and anticlockwise direction.

In some embodiments, the plurality of sensors 108 may emit the light beam 802 upon rotating in the clockwise direction and the anticlockwise direction. In some embodiments, the light beam 802 projected by at least one sensor on at least one of the plurality of shelves 404 (as illustrated in FIG. 12A). Further, the projected light beam 802 may be configured to indicate the user 408 regarding the at least one object 406 to be picked from the at least one rack 402 or placed over the at least one rack 402.

FIG. 12B illustrates another schematic view of the at least one sensor installed at a floor 1202 of the warehouse, in accordance with another alternate embodiment of the present disclosure. FIG. 12B is described in conjunction with FIG. 12A.

In some embodiments, at least one sensor from the plurality of sensors 108 may be installed at the one or more positions of inside the warehouse. Further, the one or more positions may correspond to the floor 1202 of the warehouse. In some embodiments, the at least one processor 200 may be configured to project the light beam 802 over the at least one object 406 from the floor 1202 of the warehouse. In some embodiments, the at least one sensor from the plurality of sensors 108 may be configured to rotate in the clockwise direction or the anticlockwise direction. In some embodiments, the at least one sensor from the plurality of sensors 108 may be mechanically or electrically coupled with the at least one actuator 904. Further, the rotation of the at least one sensor may be regulated by the server 104 through the at least one actuator 904. The at least one actuator 904 may control the rotation of the at least one sensor in the clockwise and anticlockwise direction.

In some embodiments, the plurality of sensors 108 may emit the light beam 802 upon rotating in the clockwise direction and the anticlockwise direction. In some embodiments, the light beam 802 projected by at least one sensor on at least one of the plurality of shelves 404 (as illustrated in FIG. 12B). Further, the projected light beam 802 may be configured to indicate the user 408 regarding the at least one object 406 to be picked from the at least one rack 402 or placed over the at least one rack 402.

In an example embodiment, a method is disclosed. The method comprises one or more operations for assisting the user 408 for managing goods within the warehouse by using the at least one sensor. At one operation, the at least one processor 200 may be configured to receive the at least one input request from the user 408. Further, the at least one input request may comprise the identification (ID) code corresponding to the at least one object 406 to be picked from the at least one rack 402 or placed over the at least one rack 402. At next operation, the at least one processor 200 may be configured to compare the received at least one input request by the user 408 having the ID code with the corresponding ID code of the at least one object 406. Further, the corresponding ID code of the at least one object 406 may be pre-saved within the memory 202. Further, the memory 202 may be configured to store the database 514 associated with an inventory record of the warehouse. Further, the database 514 may comprise the plurality of ID code(s) corresponding. In some embodiments, the server 104 may examine each of the at least one input request to identify matching ID codes among the stored data. Further, the server 104 may be configured to compare the received ID code with the corresponding ID code by the at least one synchronous approach.

At next operation, the at least one processor 200 may be configured to determine location information of the at least one object 406 to be picked from the at least one rack 402 or placed over the at least one rack 402, based at least on the comparison. At next operation, the at least one processor 200 may be configured to direct the at least one sensor placed at either at the roof 1200 or at the floor 1202 of the warehouse to rotate and project the light beam at the shelf of the at least one rack 402. Further, the light beam falling over the shelf may be configured to direct the user 408 to fetch the at least one object 406 from the shelf.

In another example embodiment, a non-transitory machine-readable information storage medium comprising one or more instructions which when executed by at least one processor 200 to perform operations. In some embodiments, the at least one processor 200 may be configured to receive the at least one input request from the user 408. Further, the at least one input request may comprise the identification (ID) code corresponding to the at least one object 406 to be picked from the at least one rack 402 or placed over the at least one rack 402. Further, the at least one processor 200 may be configured to compare the received at least one input request by the user 408 having the ID code with the corresponding ID code of the at least one object 406. Further, the corresponding ID code of the at least one object 406 may be pre-saved within the memory 202. Further, the memory 202 may be configured to store the database 514 associated with an inventory record of the warehouse. Further, the database 514 may comprise the plurality of ID code(s) corresponding. In some embodiments, the server 104 may examine each of the at least one input request to identify matching ID codes among the stored data. Further, the server 104 may be configured to compare the received ID code with the corresponding ID code by the at least one synchronous approach.

Further, the at least one processor 200 may be configured to determine location information of the at least one object 406 to be picked from the at least one rack 402 or placed over the at least one rack 402, based at least on the comparison. Thereafter, the at least one processor 200 may be configured to direct the at least one sensor placed at either at the roof 1200 or at the floor 1202 of the warehouse to rotate and project the light beam at the shelf of the at least one rack 402. Further, the light beam falling over the shelf may be configured to direct the user 408 to fetch the at least one object 406 from the shelf.

The present disclosure streamlines the process of identifying root cause of problems, indicating user 408 the location information of the at least one object 406 to be picked from the at least one rack 402 or placed over the at least one rack 402. In some embodiments, the present disclosure reduces time spent searching for items and increasing overall productivity. Further, the present disclosure guides the user 408 to the exact location of items. The present disclosure further reduces errors in picking and placing the items in the at least one rack 402.

In some alternative embodiments, the at least one rack 402 may be equipped within one or more places. The one or more places may include a shop, a vehicle such as trucks, or any other building. In one example, the at least one rack 402 may be installed within a retail shop. The user 408 may provide at least one input request that may correspond to the ID code related to a food package by using the user device 106. Further, the at least one input request may comprise the shelf ID code or the rack ID code. Further, each of the plurality of racks comprises the plurality of shelves 404 within the retail shop. The at least one processor 200 is configured to compare the at least one input with the corresponding ID code of the at least one object 406. Further, the at least one processor 200 is configured to determine location information of the at least one object 406 labeled with the ID code 130 within the retail store. Further, the plurality of sensors 108 may be installed proximity with the at least one rack 402 installed within the retail shop. Further, the plurality of sensors 108 may emit the light beam 802 upon rotating in the clockwise direction and the anticlockwise direction to intersect beam and allow the user to identify the food package.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
receiving, via at least one processor, at least one input request from a user, wherein the at least one input request comprises an identification (ID) code corresponding to at least one object to be picked from at least one rack or placed over the at least one rack;
comparing, via the at least one processor, the received at least one input request having the ID code with a corresponding ID code of the at least one object saved within a memory communicatively coupled to the at least one processor;
determining, via the at least one processor, location information of the at least one object to be picked from the at least one rack or placed over the at least one rack, based at least on the comparison, wherein the location information comprises location coordinates and a shelf number related to a shelf from a plurality of shelves of the at least one rack where the at least one object to be picked or placed; and
directing, via the at least one processor, a plurality of sensors placed at one or more positions of the at least one rack, to rotate and project a light beam at the shelf of the at least one rack from where the at least one object to be picked or placed, based at least on the determined location information, wherein the light beam from the plurality of sensors forms an intersection point over the shelf of the at least one rack to indicate the user from where the at least one object to be picked or placed.

2. The method of claim 1, wherein the one or more positions of the at least one rack comprises at least one of a placement of each of the plurality of sensors in at least top corners of the at least one rack, in at least top and bottom sides of the at least one rack, or in at least diagonal corners of the at least one rack.

3. The method of claim 1, wherein the one or more sensors comprises at least one of a laser sensor, light emitting diode (LED) sensor, or a projector sensor.

4. The method of claim 1, wherein the at least one processor is configured to rotate the plurality of sensors using at least one actuator, wherein the at least one actuator is mechanically or electrically coupled to the plurality of sensors.

5. The method of claim 4 further comprising determining, via the at least one processor, one or more angle values corresponding to the determined location coordinates of the shelf of the at least one rack from where the at least one object to be picked or placed, using the plurality of sensors.

6. The method of claim 5, wherein the at least one processor is configured to actuate the at least one actuator based at least on the determined one or more angle values, to rotate and project the light beam over the shelf of the at least one rack from where the at least one object to be picked or placed.

7. The method of claim 4, wherein the at least one processor is configured to direct the plurality of sensors placed at the one or more positions of the at least one rack, to rotate in anticlockwise direction and in clockwise direction using the at least one actuator, to form the intersection point over the shelf of the at least one rack.

8. The method of claim 1, wherein the at least one processor is communicatively coupled to a user device having an application, wherein the user device is configured to receive the at least one input request from the user using the application.

9. A system comprising:
a memory;
at least one processor communicatively coupled to the memory, wherein the at least one processor is configured to:
receive at least one input request from a user, wherein the at least one input request comprises an identification (ID) code corresponding to at least one object to be picked from at least one rack or placed over the at least one rack;
compare the received at least one input request having the ID code with a corresponding ID code of the at least one object saved within a memory communicatively coupled to the at least one processor;
determine location information of the at least one object to be picked from the at least one rack or placed over the at least one rack, based at least on the comparison, wherein the location information comprises location coordinates and a shelf number related to a shelf from a plurality of shelves of the at least one rack where the at least one object to be picked or placed; and
direct a plurality of sensors placed at one or more positions of the at least one rack, to rotate and project a light beam at the shelf of the at least one rack from where the at least one object to be picked or placed, based at least on the determined location information, wherein the light beam from the plurality of sensors forms an intersection point over the shelf of the at least one rack to indicate the user from where the at least one object to be picked or placed.

10. The system of claim 9, wherein the one or more positions of the at least one rack comprises at least one of a placement of each of the plurality of sensors in at least top corners of the at least one rack, in at least top and bottom sides of the at least one rack, or in at least diagonal corners of the at least one rack.

11. The system of claim 9, wherein the one or more sensors comprises at least one of a laser sensor, light emitting diode (LED) sensor, or a projector sensor.

12. The system of claim 9, wherein the at least one processor is configured to rotate the plurality of sensors using at least one actuator, wherein the at least one actuator is mechanically or electrically coupled to the plurality of sensors.

13. The system of claim 12, wherein the at least one processor is configured to determine one or more angle values corresponding to the determined location coordinates of the shelf of the at least one rack from where the at least one object to be picked or placed, using the plurality of sensors.

14. The system of claim 13, wherein the at least one processor is configured to actuate the at least one actuator based at least on the determined one or more angle values, to rotate and project the light beam at the shelf of the at least one rack from where the at least one object to be picked or placed.

15. The system of claim 12, wherein the at least one processor is configured to direct the plurality of sensors placed at the one or more positions of the at least one rack, to rotate in anticlockwise direction and in clockwise direction using the at least one actuator, to form the intersection point over the shelf of the at least one rack.

16. The system of claim 9, wherein the at least one processor is communicatively coupled to a user device having an application, wherein the user device is configured to receive the at least one input request from the user using the application.

17. A non-transitory machine-readable information storage medium comprising one or more instructions which when executed by at least one processor to perform operations comprising:
receiving at least one input request from a user, wherein the at least one input request comprises an identification (ID) code corresponding to at least one object to be picked from at least one rack or placed over the at least one rack;
comparing the received at least one input request having the ID code with a corresponding ID code of the at least one object saved within a memory communicatively coupled to the at least one processor;
determining location information of the at least one object to be picked from the at least one rack or placed over the at least one rack, based at least on the comparison, wherein the location information comprises location coordinates and a shelf number related to a shelf from a plurality of shelves of the at least one rack where the at least one object to be picked or placed; and
directing a plurality of sensors placed at one or more positions of the at least one rack, to rotate and project a light beam at the shelf of the at least one rack from where the at least one object to be picked or placed, based at least on the determined location information, wherein the light beam from the plurality of sensors forms an intersection point over the shelf of the at least one rack to indicate the user from where the at least one object to be picked or placed.

18. The non-transitory machine-readable information storage medium of claim 17, wherein the one or more positions of the at least one rack comprises at least one of a placement of each of the plurality of sensors in at least top corners of the at least one rack, in at least top and bottom sides of the at least one rack, or in at least diagonal corners of the at least one rack.

19. The non-transitory machine-readable information storage medium of claim 17, wherein the one or more sensors comprises at least one of a laser sensor, light emitting diode LED sensor, or a projector sensor.

20. The non-transitory machine-readable information storage medium of claim 17, wherein the at least one processor is configured to rotate the plurality of sensors using at least one actuator, wherein the at least one actuator is mechanically or electrically coupled to the plurality of sensors.
